(19) United States
(12) Patent Application Publication
(10) Pub. No.: US 2026/0242074 A1
(43) Pub. Date: Aug. 20, 2026

(54) MODULAR DRONE WITH MULTI-CONFIGURATION AND MULTI-POWER SYSTEMS

(71) Applicant: YU-HAN FAN, Taoyuan Hsien (TW)

(72) Inventor: YU-HAN FAN, Taoyuan Hsien (TW)

(21) Appl. No.: 19/394,942

(22) Filed: Nov. 20, 2025

(30) Foreign Application Priority Data
Nov. 26, 2024 (TW) 113145543

(51) Int. Cl. B64U 20/40; B64U 10/20; B64U 10/25; B64U 20/87; B64U 30/14; B64U 30/295; B64U 30/40

(52) U.S. Cl. CPC B64U 20/40; B64U 10/20; B64U 10/25; B64U 20/87; B64U 30/14; B64U 30/295; B64U 30/40

(57) ABSTRACT

A modular drone with multi-configuration and multi-propulsion systems has a main fuselage, a front fuselage, and a wing set. The main fuselage selectively has an electric stabilizer power module, or an internal combustion engine power module. The front fuselage is detachably mounted on the main fuselage via a connecting module. The wing set is detachably mounted on the main fuselage via the connecting module. Each one of the connecting modules has a protrusion, a recess, and a fixing member. When the protrusion protrudes in the recess, the fixing member is mounted through and fixes the protrusion and the recess. With the main fuselage, the front fuselage, the wing set, and the stabilizer set being connected via the connecting modules, the users may freely disassemble and reassemble the modular drone and select suitable components for rapid assembly.

### BACKGROUND OF THE INVENTION

### 1. Field of the Invention

The present invention relates to a drone, especially to a modular drone with multi-configuration and multi-propulsion systems.

### 2. Description of the Prior Arts

To address diverse application scenarios and requirements, such as silent operation, vertical takeoff and landing, extended range, high payload, electric, fuel, or hybrid-electric, a variety of drone models with distinct advantages have been developed.

However, while each conventional fixed-wing drone possesses their own advantages, they can no longer meet the various application scenarios. When different drones are needed for different situations in the same scenario, a large number of different types of drones need to be prepared, which not only incurs a lot of costs but also requires space to store the drones, resulting in limited operational flexibility.

Therefore, proposing a better solution to the aforementioned problems is urgent to the industry.

### SUMMARY OF THE INVENTION

The main objective of the present invention is to provide a modular drone with multi-configuration and multi-propulsion systems that is configured to improve the disadvantage that the conventional fixed-wing drone cannot adapt to rapid changes in the scene, and a large number of different types of drones need to be prepared, which costs a lot and requires spaces for storage.

To achieve the above objective, the modular drone with multi- configuration and multi-propulsion systems has:

a main fuselage selectively having an electric stabilizer power module or an internal combustion engine power module;

a front fuselage detachably mounted on the main fuselage via at least one connecting module;

a wing set detachably mounted on two sides of the main fuselage via the at least one connecting module.

To achieve the above objective, the modular drone with multi- configuration has:

a main fuselage;

a front fuselage detachably mounted on the main fuselage via at least one connecting module;

a wing set detachably mounted on two sides of the main fuselage via the at least one connecting module, the wing set having:

two retractable rods, each one of the retractable rods having an inner end and an outer end, the inner end pivotably mounted on one of the two sides of the main fuselage;

two vertical takeoff and landing modules respectively mounted on the two outer ends of the two retractable rods.

The advantage of this invention is that the main fuselage, the front fuselage, the wing set, and the stabilizer set are connected via the connecting modules. Therefore, users may freely disassemble and reassemble the main fuselage, the front fuselage, the wing set, and the stabilizer set and select suitable components for rapid assembly according to different operational scenarios. Meanwhile, maintaining a large inventory of different drone types is not necessary, thereby reducing costs, alleviating inventory pressure for diverse drone types, and enhancing operational flexibility.

### BRIEF DESCRIPTION OF THE DRAWINGS

FIG. 1 is a perspective schematic view of a modular drone in accordance with the present invention, shown as an electric fixed-wing drone;

FIG. 2 is a perspective schematic view of a modular drone in accordance with the present invention, shown as an electric vertical take-off and landing fixed-wing drone;

FIG. 3 is a perspective schematic view of a modular drone in accordance with the present invention, shown as an internal combustion engine power fixed- wing drone;

FIG. 4 is a perspective schematic view of a modular drone in accordance with the present invention, shown as an internal combustion engine power vertical take-off and landing fixed-wing drone;

FIG. 5 is a perspective schematic view of a modular drone in accordance with the present invention, shown as a heavy-duty, long-endurance biplane vertical take-off and landing fixed-wing drone;

FIG. 6 is a perspective schematic view of a modular drone in accordance with the present invention, shown as an electric multirotor drone;

FIG. 7 is a cross-sectional schematic view of a connecting module of the present invention;

FIG. 8 is an exploded schematic view of the connecting module of the present invention;

FIG. 9 is a perspective schematic view of an electric stabilizer power module of the present invention;

FIG. 10 is a perspective schematic view of an internal combustion engine power module of the present invention;

FIG. 11 is a perspective schematic view of a front fuselage of the present invention;

FIG. 12 is a front schematic view of the front fuselage of the present invention;

FIG. 13 is a side schematic view of the front fuselage of the present invention;

FIG. 14 is a perspective schematic view of a high-lift wing module of the present invention, shown opened;

FIG. 15 is a perspective schematic view of the high-lift wing module of the present invention, shown closed;

FIG. 16 is a perspective schematic view of a V-shaped stabilizer module of the present invention;

FIG. 17 is a perspective schematic view of an H-shaped stabilizer module of the present invention;

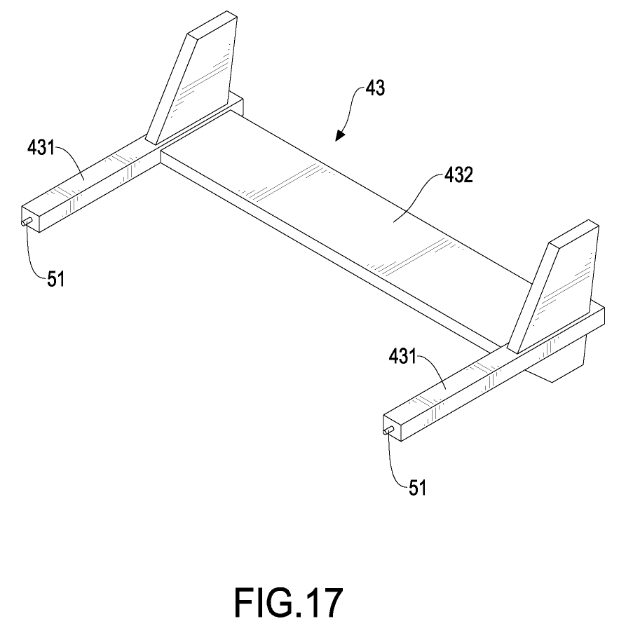

FIG. 18 is a perspective schematic view of a modular drone in accordance with the present invention, shown as a quadrotor drone extending outward;

FIG. 19 is a perspective schematic view of the quadrotor drone of the present invention, shown folded;

FIG. 20 is an exploded view of a connecting module of the quadrotor drone of the present invention;

FIG. 21 is a perspective schematic view of the quadrotor drone of the present invention, shown installed with a center wing module and an electric stabilizer power module 11;

FIG. 22 is a cross-sectional schematic view of the quadrotor drone of the present invention;

FIG. 23 is a perspective schematic view of a modular drone in accordance with the present invention, shown as an X-wing drone; and

FIG. 24 is a perspective schematic view of an embodiment of a modular drone in accordance with the present invention.

### DETAILED DESCRIPTION OF THE PREFERRED EMBODIMENTS

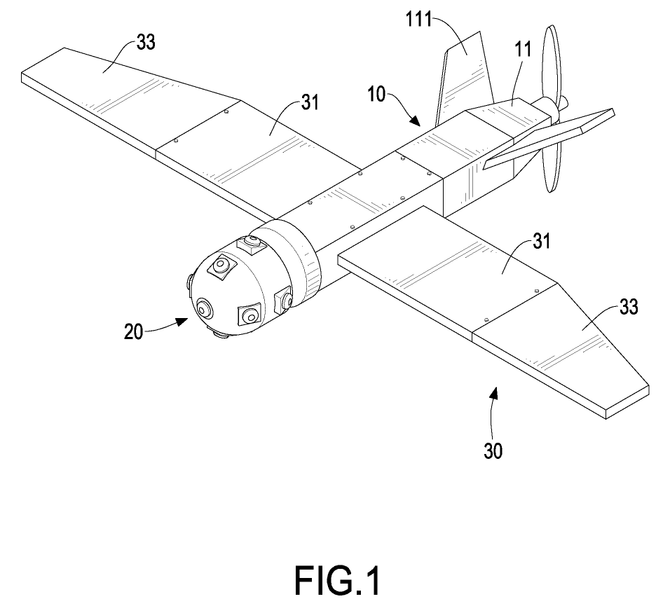

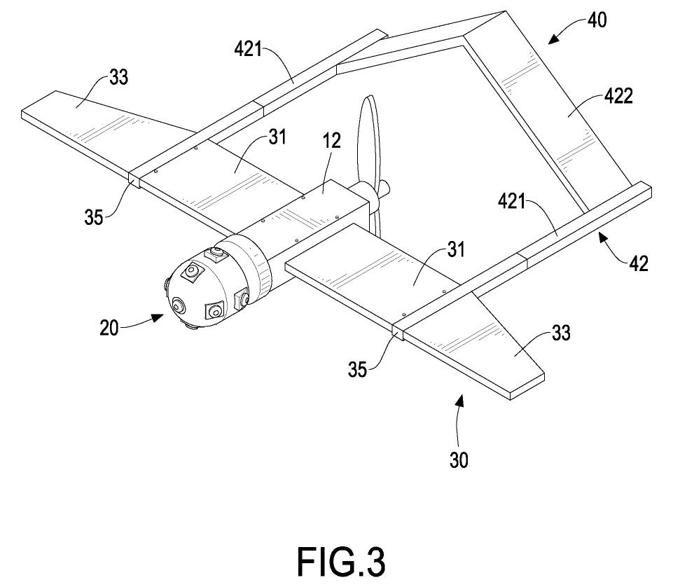

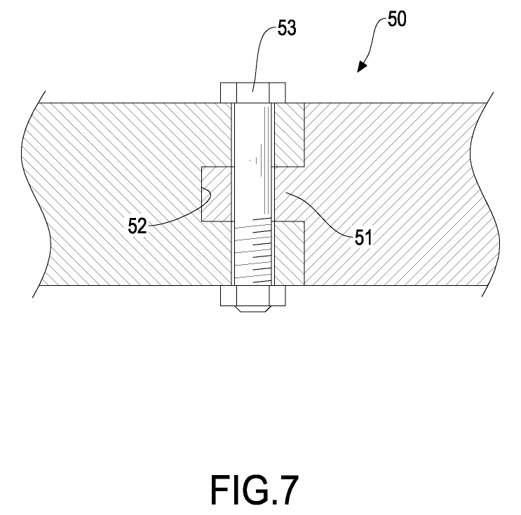

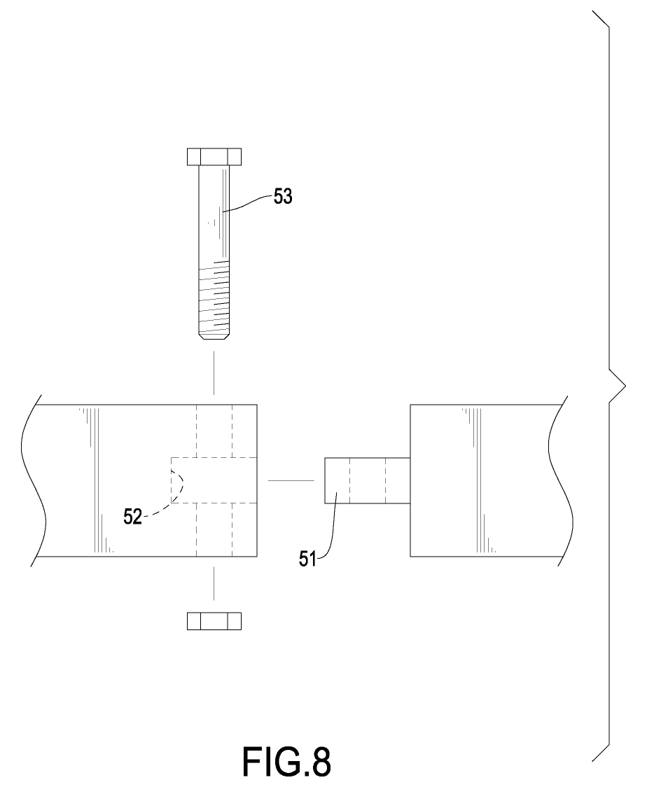

With reference to FIG. 1, FIG. 3, FIG. 7 and FIG. 8, a modular drone with multi-configuration and multi-propulsion systems in accordance with the present invention comprises a main fuselage 10, a front fuselage 20, a wing set 30, and a stabilizer set 40. The front fuselage 20 and the wing set 30 are detachably mounted on the main fuselage 10 via at least one connecting module 50, and the stabilizer set 40 is detachably connected to the wing set 30 via the at least one connecting module 50. In other words, in this embodiment, the main fuselage 10, the front fuselage 20, the wing set 30, and the stabilizer set 40 are assembled by the connecting modules 50.

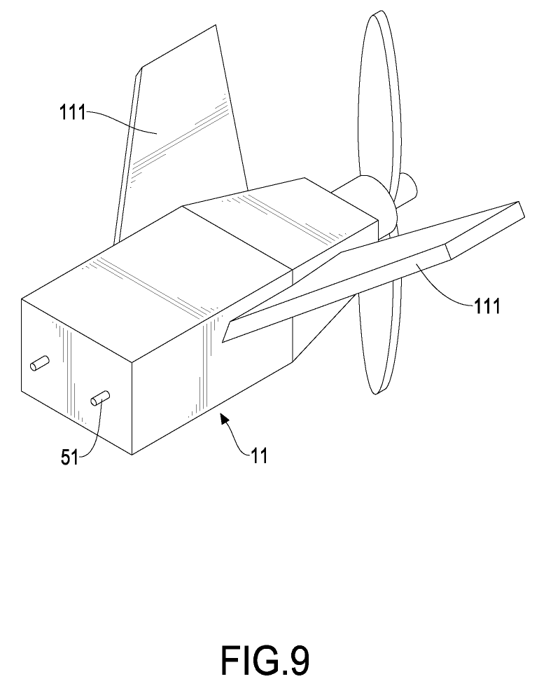

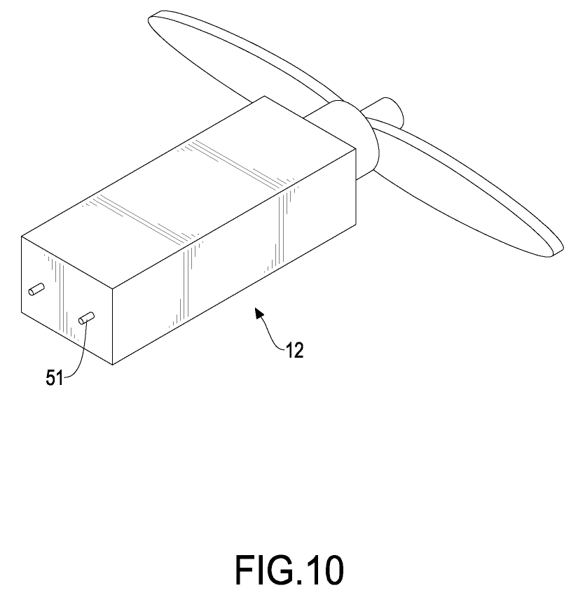

With reference to FIG. 1, FIG. 9 and FIG. 10, the main fuselage 10 selectively comprises an electric stabilizer power module 11 or an internal combustion engine power module 12. The electric stabilizer power module 11 is electrically driven and comprises two electric power module stabilizers 111. The internal combustion engine power module 12 is driven by an oil engine. In other words, users may choose to operate the modular drone by using either the electric stabilizer power module 11 or the internal combustion engine power module 12.

With reference to FIG. 1, FIG. 7 and FIG. 8, the front fuselage 20 is detachably mounted on the main fuselage 10 via the connecting module 50. The connecting module 50 comprises at least one protrusion 51, at least one recess 52, and at least one fixing member 53. A number of the at least one protrusion 51, a number of the at least one recess 52, and a number of the at least one fixing member 53 correspond to each other. The protrusion 51 and the recess 52 are disposed on different parts, such as on a junction between the main fuselage 10 and the front fuselage 20 in this embodiment. The protrusion 51 is disposed on the main fuselage 10 and extends toward the front fuselage 20, and the recess 52 is disposed on the front fuselage 20 near the main fuselage 10. The protrusion 51 protrudes in the recess 52. When the protrusion 51 protrudes in the recess 52, the fixing member 53 is mounted through and is fixed to the protrusion 51 and the recess 52, so that the front fuselage 20 is connected to the main fuselage 10. In another embodiment, the structure of the connecting module 50 is not limited thereto. The connecting module 50 may also comprise two tubes respectively mounted on the main fuselage 10 and the front fuselage 20, and the two tubes are sleeved with each other and are secured with bolts.

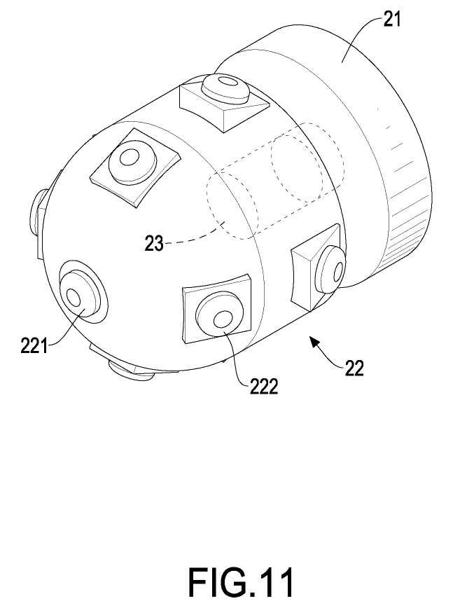

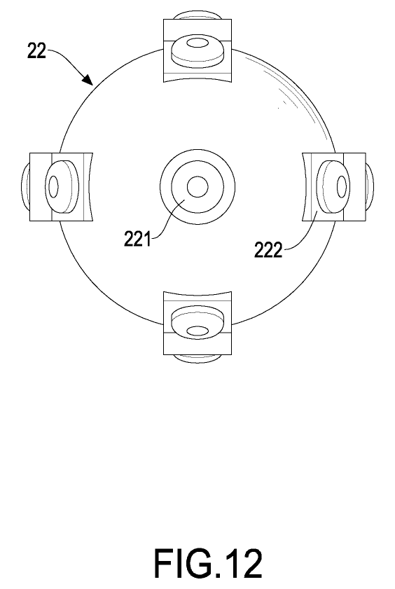

With reference to FIG. 11 and FIG. 12, the front fuselage 20 comprises a chassis 21, a camera mounting base 22, and a rotary motor 23. The chassis 21 is detachably connected to the main fuselage 10 via the at least one connecting module 50. The camera mounting base 22 is located on one end, which is away from the main fuselage 10, of the front fuselage 20 and comprises multiple cameras 221,222 arranged at equiangular intervals.

In this embodiment, the camera mounting base 22 comprises a primary camera 221 and eight sensing cameras 222. The primary camera 221 is mounted on one end, which is away from the main fuselage 10, of the front fuselage 20 and features zoom functionality. The sensing cameras 222 are arranged in two groups of four, each group of the sensing cameras 222 surrounds the primary camera 221 at equal angles. In other words, a primary camera 221, one of the other groups of the sensing cameras 222 and the other groups of the sensing cameras 222 are arranged sequentially from one end, which is away from the main fuselage 10, of the front fuselage 20 toward the main fuselage 10. The four sensing cameras 222 near the primary camera 221 face diagonally forward, and the other four sensing cameras 222 face diagonally backward. Therefore, the front fuselage 20 perceives the surrounding environment in all directions, rather than relying solely on rotation of one single camera 221, 222 to receive information, enabling broader and faster data collection. In another embodiment, the facing directions of the primary camera 221 and the sensing camera 222 are not limited thereto. In addition, each one of the cameras 221, 222 can be configured with distinct functionalities. Precisely, the users may install the cameras 221, 222 with various capabilities, such as wide-angle, telephoto, infrared, multispectral, or thermal imaging, based on specific application scenarios and requirements.

The rotary motor 23 is connected to the chassis 21 and pivotably mounted on the camera mounting base 22 to allow the camera mounting base 22 to rotate. Precisely, the rotary motor 23 comprises a rotary shaft (not shown in figures), and the camera mounting base 22 is sleeved on the rotary shaft. When the rotary shaft of the rotary motor 23 rotates, the camera mounting base 22 rotates accordingly, so that each camera 221, 222 on the camera mounting base 22 may capture images from multiple directions within a short timeframe and collect information.

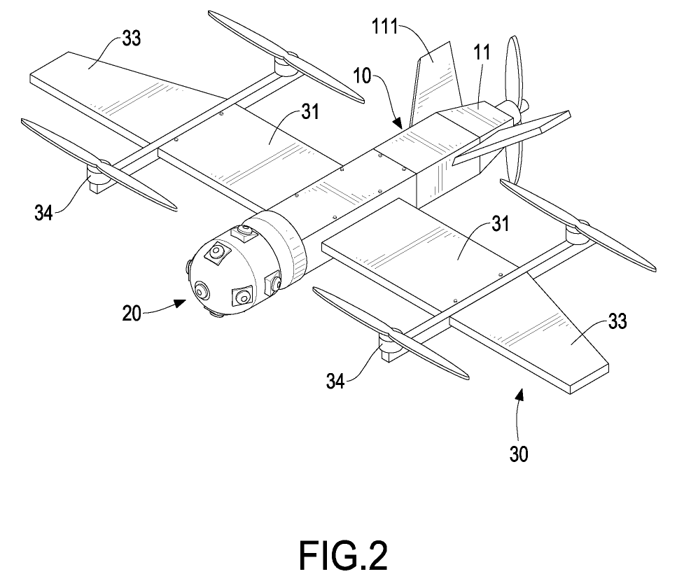

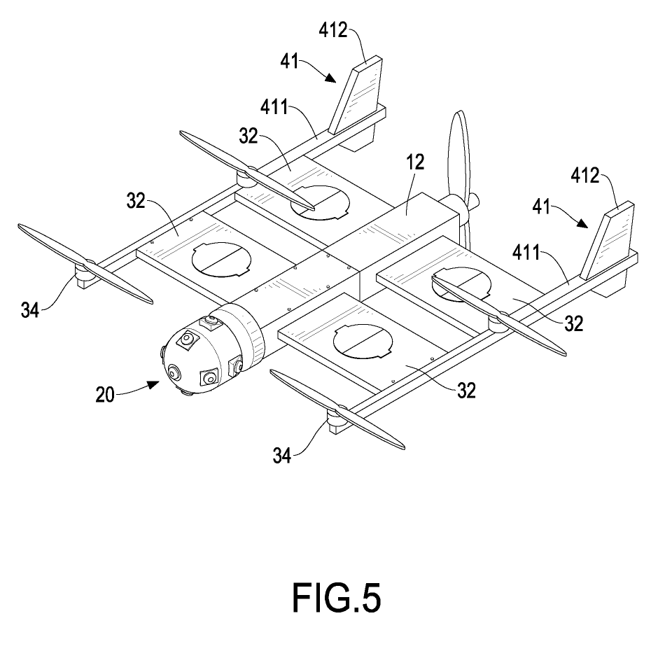

With reference to FIG. 1, FIG. 2 and FIG. 5, the wing set 30 is detachably mounted on two sides of the main fuselage 10 via the connecting modules 50. The wing set 30 comprises two wing modules 31, multiple high-lift wing modules 32, two long-range wing modules 33, and two vertical takeoff and landing modules 34. The two wing modules 31 are detachably connected to the two sides of the main fuselage 10 via the connecting modules 50. The users may selectively configure any combination of the two wing modules 31, the multiple high-lift wing modules 32, the two long-range wing modules 33, or the two vertical takeoff and landing modules 34. The modules can be detachably mounted on the fuselage 10 via the connecting modules 50.

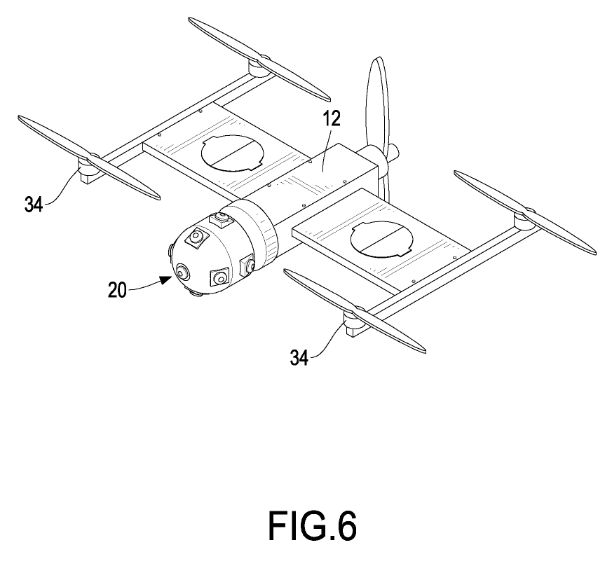

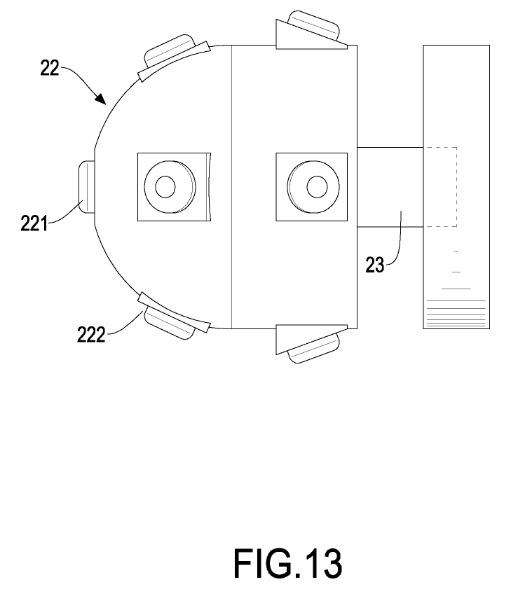

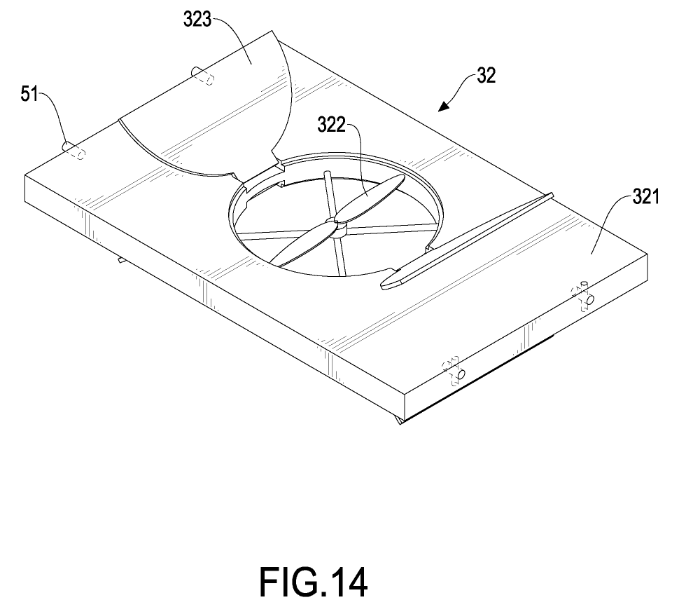

With reference to FIG. 5, FIG. 6, FIG. 13 and FIG. 14, the high-lift wing modules 32 are detachably connected to the main fuselage 10 via the connecting module 50, and each one of the high-lift wing modules 32 comprises a casing 321, a fan 322, and at least one cover 323. The fan 322 is mounted in the casing 321 of the high-lift wing module 32 and parallel to a wing surface of the high- lift wing module 32. The cover 323 is pivotably mounted on the casing 321 and may selectively block air from passing through the fan 322. When the cover 323 rotates to open and the fan 322 is opened, air flows from an underside of the fan 322 to pass through the fan 322 and to flow to a top of the fan 322, thereby generating lift to assist the ascent.

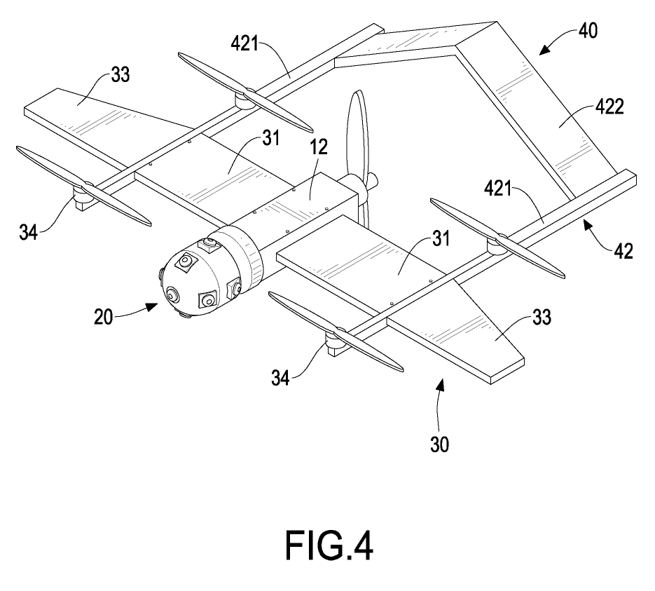

With reference to FIG. 1 and FIG. 5, each one of the long-range wing modules 33 is detachably connected to one of the wing modules 31 or one of the high-lift wing modules 32 via the connecting module 50. With reference to FIG. 2, FIG. 4, and FIG. 6, each one of the vertical takeoff and landing modules 34 is mounted between one of the long-range wing modules 33 and one of the wing modules 31 or between one of the long-range wing modules 33 and one of the high-lift wing modules 32. Precisely, the vertical takeoff and landing module 34 comprises at least one hole. When the long-range wing module 33 is connected to the wing module 31 or the high-lift wing module 32, each one of the protrusions 51 of the connecting module 50 is mounted through one of the at least one hole of the vertical takeoff and landing module 34 and protrudes in the recess 52. Therefore, the vertical takeoff and landing module 34 may also be securely connected with the wing module 31 or the high-lift wing module 32.

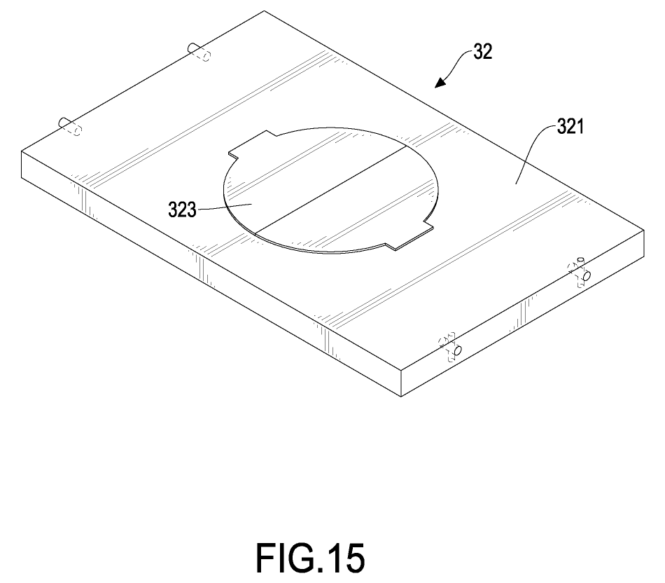

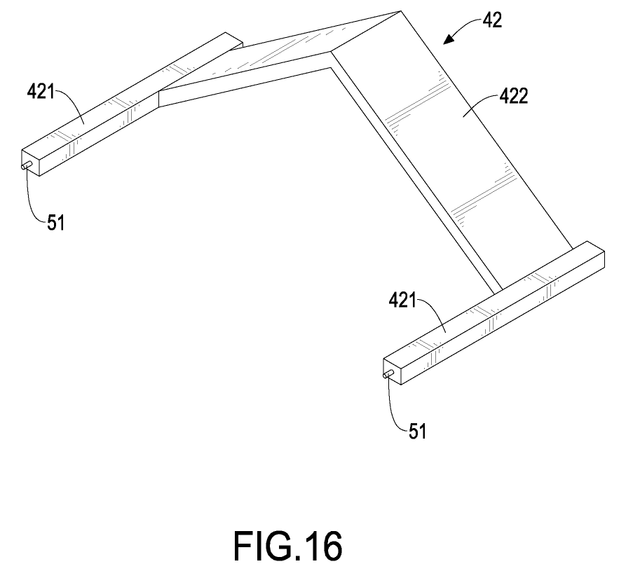

With reference to FIG. 3, FIG. 5, FIG. 15, and FIG. 16, the stabilizer set 40 is detachably connected to the wing set 30 via the connecting modules 50. The stabilizer set 40 may selectively comprise two vertical stabilizer modules 41, a V-shaped stabilizer module 42, or an H-shaped stabilizer module 43. Each one of the vertical stabilizer modules 41 comprises a vertical stabilizer bracket 411 and a vertical stabilizer 412. The vertical stabilizer bracket 411 is connected to one of the vertical takeoff and landing modules 34. The vertical stabilizer 412 is perpendicular to the wing set 30, and mounted on one of the vertical stabilizer brackets 411. With reference to FIG. 14, the V-shaped stabilizer module 42 comprises two V-shaped stabilizer brackets 421 and a V-shaped stabilizer 422. The two V-shaped stabilizer brackets 421 are connected to the vertical takeoff and landing modules 34 respectively. The V-shaped stabilizer 422 is inverted V- shaped and connected to the two V-shaped stabilizer brackets 421. With reference to FIG. 15, the H-shaped stabilizer module 43 comprises two H-shaped stabilizer brackets 431 and an H-shaped stabilizer 432. The two H-shaped stabilizer brackets 431 are connected to the vertical takeoff and landing modules 34 respectively. The H-shaped stabilizer 432 is a plate and connected to the two H-shaped stabilizer brackets 431.

With reference to FIG. 1, to assemble the modular drone into an electric fixed-wing drone, the two wing modules 31 are mounted on the main fuselage 10 with the electric stabilizer power module 11 via the connecting modules 50. The two long-range wing modules 33 are respectively mounted on the two wing modules 31 via the connecting modules 50, and the front fuselage 20 is mounted on the main fuselage 10 via the connecting module 50. With reference to FIG. 2, the way to assemble the modular drone into an electric vertical take-off and landing fixed-wing drone is similar to the electric fixed-wing drone, and the difference is only in that, the vertical takeoff and landing module 34 is mounted between the wing module 31 and the long-range wing module 33 to improve the drone's vertical take-off and landing capability.

With reference to FIG. 3, to assemble the modular drone into an internal combustion engine power fixed-wing drone, the two wing modules 31 are mounted on the main fuselage 10 with the internal combustion engine power module 12 via the connecting modules 50. Then the two long-range wing modules 33 are respectively mounted on the two wing modules 31 via the connecting modules 50, and the front fuselage 20 is mounted on the main fuselage 10 via the connecting module 50. In this embodiment, an extension rod 35 is mounted between the wing module 31 and the long-range wing module 33. The connection method of the extension rod 35 is the same as the connection method of the vertical takeoff and landing module 34, and the extension rod 35 is configured to connect the stabilizer set 40 to the wing set 30 via the connecting module 50. The V-shaped stabilizer module 42 is mounted on the extension rod 35 via the connecting module 50. Precisely, the V-shaped stabilizer bracket 421 and the extension rod 35 are connected to each other via the connecting module 50. With reference to FIG. 4, the way to assemble the modular drone into an internal combustion engine power vertical take-off and landing fixed-wing drone is similar to the internal combustion engine power fixed-wing drone, and the difference is only in that the extension rod 35 located between the wing module 31 and the long-range wing module 33 is substituted by the vertical takeoff and landing module 34 to improve the drone's vertical take-off and landing capability.

With reference to FIG. 5, to assemble the modular drone into a heavy- duty, long-endurance biplane vertical take-off and landing fixed-wing drone, the multiple high-lift wing modules 32 and the front fuselage 20 are mounted on the main fuselage 10 via the connecting modules 50, and the vertical takeoff and landing module 34 and the vertical stabilizer module 41 are mounted on the high- lift wing module 32 via the connecting modules 50. The fan 322 of the high-lift wing module 32 may generate lift so as to allow the drone to hover. Meanwhile, the vertical takeoff and landing module 34 and the vertical stabilizer module 41 may also improve the drone's vertical take-off and landing capability.

With reference to FIG. 6, to assemble the modular drone into an electric multirotor drone, the multiple high-lift wing modules 32 and the front fuselage 20 are mounted on the main fuselage 10 via the connecting modules 50, and then the vertical takeoff and landing module 34 is mounted on the high-lift wing module 32 via the connecting module 50. The assembly method of this invention is not limited thereto, and may be adjusted according to the user's need.

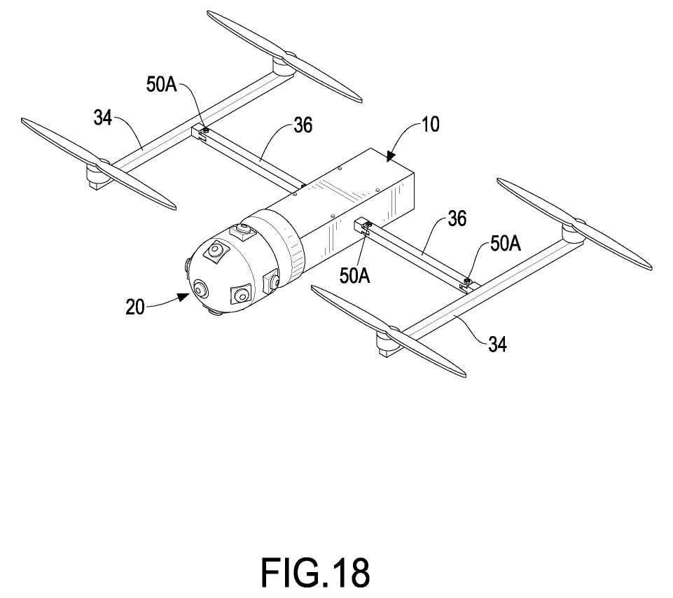

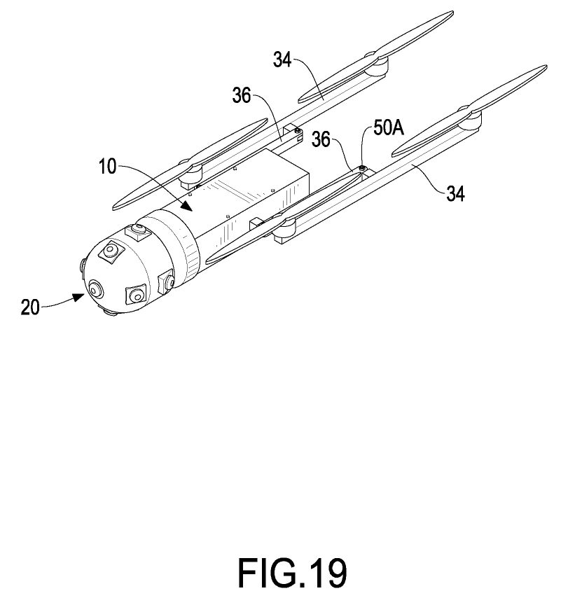

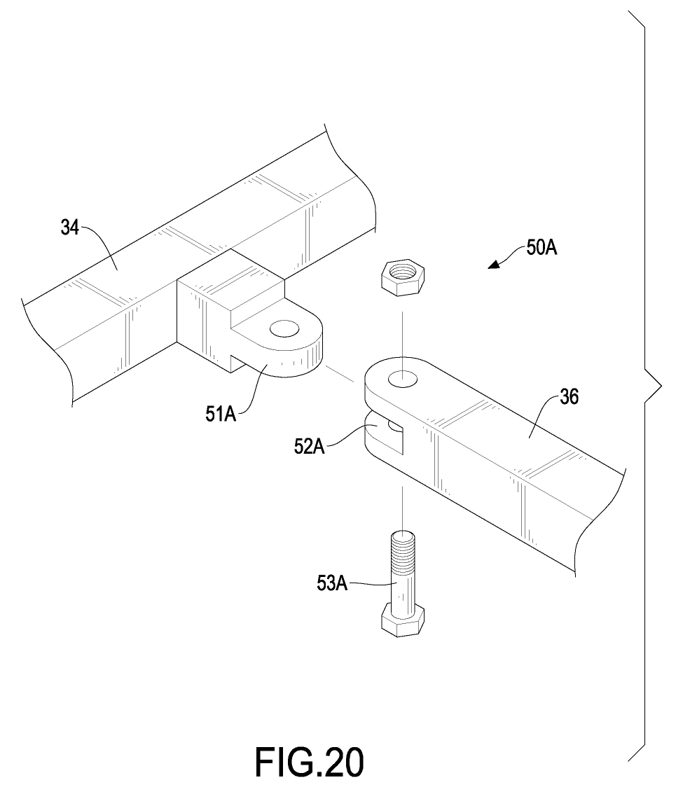

With reference to FIG. 18 to FIG. 20, to assemble the modular drone into a quadrotor drone, the front fuselage 20 and the wing set 30 are mounted on the main fuselage 10 via the connecting modules 50A. In this embodiment, the connecting module 50A is similar to the connecting module 50 in the above embodiment, with the difference only in that, in this embodiment, the protrusion 5 lA and the recess 52A may pivot relative to each other on the fixing member 53A, and the protrusion 5 lA and the recess 52A may be fixed at a specific angle. Therefore, the front fuselage 20 and the wing set 30 can also pivot relative to the main fuselage 10 and be fixed at specific angles. In this embodiment, the wing set 30 comprises two retractable rods 36 and two vertical takeoff and landing modules 34 and preferably comprises two center wing modules 37.

Each one of the retractable rods 36 comprises an inner end 361 and an outer end 362. The inner end 361 is detachably mounted on the main fuselage 10 via the connecting module 50A and is foldable toward one of the sides of the main fuselage 10. Precisely, the inner end 361 is pivotably mounted on one of the sides of the main fuselage 10. Each one of the vertical takeoff and landing modules 34 is preferably mounted on the outer end 362 of a corresponding one of the retractable rods 36 via the connecting module 50A. Therefore, each one of the vertical takeoff and landing modules 34 may be folded toward the main fuselage 10 via the corresponding one of the retractable rods 36 to reduce the volume during storage.

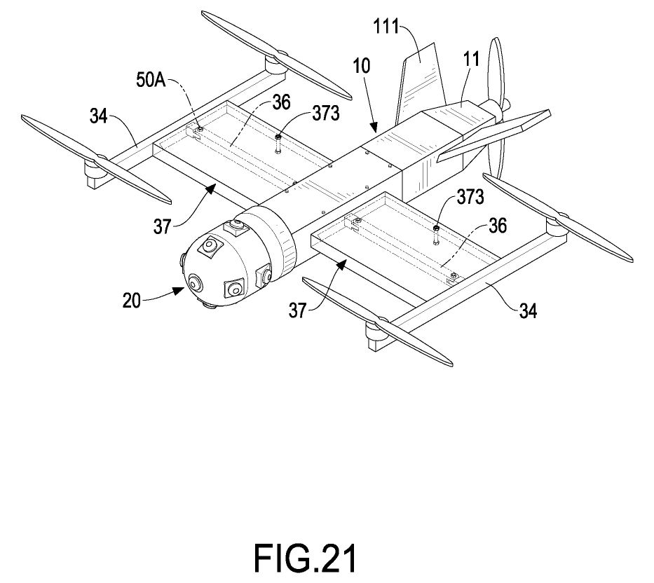

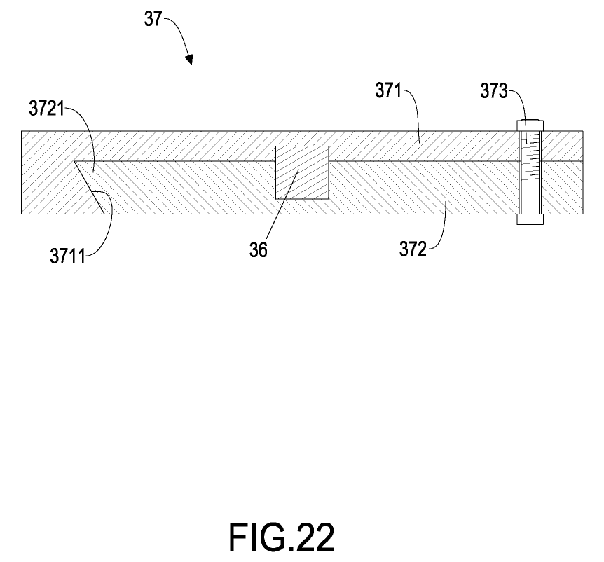

With reference to FIG. 21 and FIG. 22, to ensure sufficient power and stability for the drone during flight, the number of the electric stabilizer power module 11 and the number of the electric power module stabilizer 111 of the electric stabilizer power module 11 in the quadrotor drone may be increased, and the wing set 30 may comprise two center wing modules 37. The two center wing modules 37 are respectively mounted on the two sides of the main fuselage 10. Each one of the center wing modules 37 comprises a first center wing member 371 and a second center wing member 372, and preferably comprises at least one fastener 373. When the two retractable rods 36 extend outward from the main fuselage 10, the first center wing member 371 and the second center wing member 372 of each one of the center wing modules 37 detachably clamp one of the retractable rods 36 and restrict the retractable rod 36 folding toward the main fuselage 10.

In this embodiment, the first center wing member 371 and the second center wing member 372 are plate-shaped, and two sides of the first center wing members 371 respectively abut the main fuselage 10 and one of the vertical takeoff and landing modules 34. Therefore, when the vertical takeoff and landing module 34 is folded toward the main fuselage 10 via the retractable rod 36, the retractable rod 36 is unable to be folded or rotate due to blocking of the first center wing member 371. Preferably, two sides of each one of the second center wing members 372 also respectively abut the main fuselage 10 and one of the vertical takeoff and landing modules 34 and restrict the two retractable rods 36 folding toward the main fuselage 10, but it is not limited thereto.

In this embodiment, the first center wing member 371 is mounted on a top surface of the retractable rod 36 and comprises a first embedded member 3711. The second center wing member 372 is mounted on a bottom surface of the retractable rod 36 and comprises a second embedded member 3721. The second embedded member 3721 may be embedded in the first embedded member 3711. The fastener 373 is mounted through the first center wing member 371 and is fixed to the second center wing member 372. The first embedded member 3711 and the second embedded member 3721 are spaced apart, so that the retractable rod 36 is fixed between the first center wing member 371 and the second center wing member 372. In another embodiment, the center wing module 37 may not comprise the fastener 373, instead relying on the second embedded member 3721 embedded in the first embedded member 3711 to secure the retractable rod 36 within the center wing module 37.

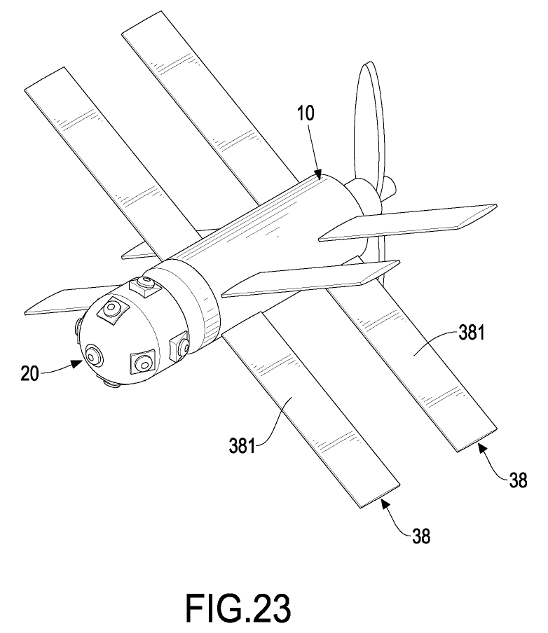

With reference to FIG. 23, to assemble the modular drone into an X-wing drone, the front fuselage 20 and the wing set 30 are mounted on the main fuselage 10 via the connecting modules 50. In this embodiment, the wing set 30 comprises two wing assemblies 38 spaced apart along a lengthwise direction of the main fuselage 10. Each one of the wing assemblies 38 comprises multiple wing flaps 381, and the multiple wing flaps 381 are arranged at spaced intervals around the main fuselage 10. Precisely, the wing assemblies 38 form an X shape, but it is not limited thereto.

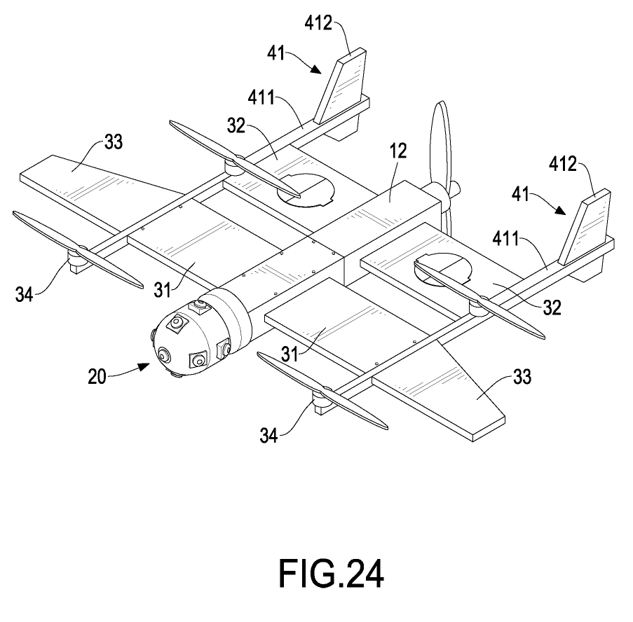

With reference to FIG. 24, in this embodiment, the two wing modules 31, the two high-lift wing modules 32 and the front fuselage 20 are mounted on the main fuselage 10 via the connecting modules 50 respectively. The vertical takeoff and landing modules 34 and the vertical stabilizer module 41 are mounted on the wing module 31 and the high-lift wing module 32 via the connecting modules 50. Lastly, the two long-range wing modules 33 are connected to the two vertical takeoff and landing modules 34 via the connecting modules 50. Therefore, in this embodiment, the fan 322 of the high-lift wing module 32 may generate lift to assist the ascent and allow the drone to hover, and the vertical takeoff and landing modules 34 and the vertical stabilizer module 41 also improve the drone's vertical take-off and landing capability. Meanwhile, the long-range wing module 33 enhances the gliding capability of the drone in this embodiment.

The advantage of this invention is that the main fuselage 10, the front fuselage 20, the wing set 30, and the stabilizer set 40 are connected via the connecting modules 50. Therefore, the users may freely disassemble and reassemble the main fuselage 10, the front fuselage 20, the wing set 30, and the stabilizer set 40 and select suitable components for rapid assembly according to different operational scenarios. Meanwhile, maintaining a large inventory of different drone types is not necessary, thereby reducing costs, alleviating inventory pressure for diverse drone types, and enhancing operational flexibility.

What is claimed is:

1. A modular drone with multi-configuration and multi-propulsion
systems comprising:a main fuselage selectively comprising an electric stabilizer power
module or an internal combustion engine power module;a front fuselage detachably mounted on the main fuselage via at least
one connecting module; anda wing set detachably mounted on two sides of the main fuselage via the
at least one connecting module.

2. The modular drone with multi-configuration and multi-propulsion
systems as claimed in claim 1, wherein each one of the at least one connecting module comprises:a protrusion and a recess, the protrusion protruding in the recess; anda fixing member, wherein when the protrusion protrudes in the recess,
the fixing member is mounted through and fixed to the protrusion and the recess.

3. The modular drone with multi-configuration and multi-propulsion
systems as claimed in claim 1, wherein,the electric stabilizer power module is electrically driven and comprises:two electric power module stabilizers respectively mounted on
two sides of the electric stabilizer power module; or the internal combustion engine power module is driven by an oil engine.

4. The modular drone with multi-configuration and multi-propulsion
systems as claimed in claim 1, wherein, the wing set comprises:two wing modules detachably connected to the main fuselage;
multiple high-lift wing modules detachably connected to the main
fuselage, and each one of the high-lift wing modules comprising:a casing;a fan mounted in the casing of the high-lift wing module and
being parallel to a wing surface of the high-lift wing module;at least one cover pivotably mounted on the casing and being
capable of blocking air from passing through the fan;two long-range wing modules, each one of the long-range wing modules
detachably connected to one of the wing modules or one of the high-lift wing modules.

5. The modular drone with multi-configuration and multi-propulsion
systems as claimed in claim 4, wherein, the wing set further comprises:two vertical takeoff and landing modules, each one of the vertical takeoff
and landing modules mounted between one of the long-range wing modules and one of the wing modules or between one of the long-range wing modules and one of the high-lift wing modules.

6. The modular drone with multi-configuration and multi-propulsion
systems as claimed in claim 5 further comprising a stabilizer set, the stabilizer set detachably connected to the vertical takeoff and landing module via the at least one connecting module; the stabilizer set selectively comprising two vertical stabilizer modules, a V-shaped stabilizer module, or an H-shaped stabilizer module.

7. The modular drone with multi-configuration and multi-
propulsion systems as claimed in claim 1 further comprising a stabilizer 17
set, the stabilizer set detachably connected to the vertical takeoff and landing module via the at least one connecting module; the stabilizer set selectively comprising two vertical stabilizer modules, a V-shaped stabilizer module,
or an H-shaped stabilizer module.

8. The modular drone with multi-configuration and multi-propulsion
systems as claimed in claim 7, wherein, each one of the vertical stabilizer modules comprises:a vertical stabilizer bracket connected to one of the wing sets;a vertical stabilizer perpendicular to the wing set and mounted
on one of the vertical stabilizer brackets.

9. The modular drone with multi-configuration and multi-propulsion
systems as claimed in claim 7, wherein, the V-shaped stabilizer module comprises:two V-shaped stabilizer brackets respectively connected to the
wing set;a V-shaped stabilizer being inverted V-shaped and connected to
the two V-shaped stabilizer brackets.

10. The modular drone with multi-configuration and multi-propulsion
systems as claimed in claim 7, wherein, the H-shaped stabilizer module comprises:two H-shaped stabilizer brackets respectively connected to one
of the wing sets;an H-shaped stabilizer being a plate and connected to the wing
10set.

11. The modular drone with multi-configuration and multi-propulsion
systems as claimed in claim 1, wherein, the front fuselage further comprises:a chassis detachably connected to the main fuselage via the at least one
connecting module;a camera mounting base located on one end, which is away from the
main fuselage, of the front fuselage, and comprising:multiple cameras arranged at equiangular intervals;
a rotary motor connected to the chassis and pivotably mounted on the
camera mounting base, and the rotary motor being capable of rotating the camera mounting base.

12. The modular drone with multi-configuration and multi-propulsion
systems as claimed in claim 1, wherein, the wing set comprises:two retractable rods, each one of the retractable rods comprising an inner
end and an outer end, and the inner end detachably mounted on the main fuselage via the at least one connecting module and being foldable toward one side of the two sides of the main fuselage;two vertical takeoff and landing modules respectively mounted on the
two outer ends of the two retractable rods;two center wing modules; each one of the center wing modules
comprising a first center wing member and a second center wing member;
wherein when the two retractable rods extend outward from the main fuselage, the first center wing member and the second center wing member of each one of
the center wing modules detachably clamp one of the retractable rods and restrict the retractable rod folding toward the main fuselage.

13. The modular drone with multi-configuration and multi-propulsion
systems as claimed in claim 11, wherein, the wing set comprises:two retractable rods, each one of the retractable rods comprising an inner
end and an outer end, and the inner end detachably mounted on the main fuselage via the at least one connecting module and being foldable toward one side of the two sides of the main fuselage;two vertical takeoff and landing modules respectively mounted on the
two outer ends of the two retractable rods;two center wing modules; each one of the center wing modules
comprising a first center wing member and a second center wing member;
wherein when the two retractable rods extend outward from the main fuselage, the first center wing member and the second center wing member of each one of
the center wing modules detachably clamp a corresponding one of the retractable rods and restrict the retractable rod folding toward the main fuselage.

14. The modular drone with multi-configuration and multi-propulsion
systems as claimed in claim 12, wherein, the two first center wing members are plate-shaped; two sides of each one of the first center wing members respectively abut the main fuselage and one of the vertical takeoff and landing modules to restrict the corresponding one of the retractable rods folding toward the main fuselage.

15. The modular drone with multi-configuration and multi-propulsion
systems as claimed in claim 13, wherein, the two first center wing members are plate-shaped; two sides of each one of the first center wing members respectively abut the main fuselage and one of the vertical takeoff and landing modules to 20
restrict the corresponding one of the retractable rods folding toward the main fuselage.

16. The modular drone with multi-configuration and multi-propulsion
systems as claimed in claim 12, wherein,the first center wing member of each one of the center wing modules is
mounted on a top surface of the corresponding one of the retractable rods and comprises a first embedded member;the second center wing member of each one of the center wing modules
is mounted on a bottom side of the corresponding one of the retractable rods and comprises a second embedded member, and the first embedded member is embedded in the second embedded member;each one of the center wing modules further comprises a fastener
mounted through the first center wing member and fixed to the second center wing member, and the first embedded member and the second embedded member are spaced apart from the fastener.

17. The modular drone with multi-configuration and multi-propulsion
systems as claimed in claim 15, wherein,the first center wing member of each one of the center wing modules is
mounted on a top surface of the corresponding one of the retractable rods and comprises a first embedded member;the second center wing member of each one of the center wing modules
is mounted on a bottom side of the corresponding one of the retractable rods and comprises a second embedded member, and the first embedded member is embedded in the second embedded member;
each one of the center wing modules further comprises a fastener
mounted through the first center wing member and fixed to the second center wing member, and the first embedded member and the second embedded member are spaced apart from the fastener.

18. The modular drone with multi-configuration and multi-propulsion
systems as claimed in claim 1, wherein, the wing set comprises two wing assemblies spaced apart along the lengthwise direction of the main fuselage, and
each one of the wing assemblies comprises multiple wing flaps, the wing flaps
arranged at spaced intervals around the main fuselage.

19. The modular drone with multi-configuration and multi-propulsion
systems as claimed in claim 11, wherein, the wing set comprises two wing assemblies spaced apart along a lengthwise direction of the main fuselage, and
each one of the wing assemblies comprises multiple wing flaps, the wing flaps
arranged at spaced intervals around the main fuselage.

20. A modular drone for multi-configuration comprising:
a main fuselage;
a front fuselage detachably mounted on the main fuselage via at least
one connecting module;a wing set detachably mounted on two sides of the main fuselage via the
at least one connecting module, and the wing set comprising:two retractable rods, each one of the retractable rods comprising
an inner end and an outer end, and the inner end detachably mounted on the main fuselage via the at least one connecting module and being foldable toward one side of the two sides of the main fuselage;
two vertical takeoff and landing modules respectively mounted
on the two outer ends of the two retractable rods.
